(19) United States
(12) Patent Application Publication
(10) Pub. No.: US 2015/0324093 A1
(43) Pub. Date: Nov. 12, 2015

(54) INFORMATION DISPLAY DEVICE AND METHOD OF CHANGING DISPLAY LAYOUT ON INFORMATION DISPLAY DEVICE

(71) Applicant: Furuno Electric Co., Ltd., Nishinomiya (JP)

(72) Inventors: Tomoo Wada, Nishinomiya-shi (JP); Jyunya Higuchi, Nishinomiya-shi (JP)

(21) Appl. No.: 14/706,668

(22) Filed: May 7, 2015

(30) Foreign Application Priority Data
May 8, 2014 (JP) 2014-096427

(51) Int. Cl. G06F 3/0484; G06F 3/0481

(52) U.S. Cl. CPC G06F 3/04842; G06F 3/0481

(57) ABSTRACT

An information display device is provided. The information display device includes a display reference position selecting module configured to allow a user to select, as an information display reference position, one of rectangular unit segments formed by dividing an information item display target section, a display item selecting module configured to allow a user to select an item of information to be displayed in a part of the information item display target section, a display size selecting module configured to acquire one or more displayable sizes that fit inside the part of the information item display target section, and allow a user to select, from the one or more displayable sizes, a size for the selected item to be displayed therein, and a display unit configured to display the selected item in the selected size in the part of the information item display target section.

### CROSS-REFERENCE TO RELATED APPLICATION(S)

This application claims priority under 35 U.S.C. §119 to Japanese Patent Application No. 2014-096427, which was filed on May 8, 2014, the entire disclosure of which is hereby incorporated by reference.

### TECHNICAL FIELD

This disclosure generally relates to an information display device, which displays various kinds of information on a single display screen.

### BACKGROUND OF THE INVENTION

Recently, to improve viewability of simultaneously referring to various kinds of information, various information display devices and methods of displaying information are provided to users. In such an information display device and method of displaying information, a plurality of information items are displayed simultaneously on a single display screen by dividing the display screen. JP2009-080710A, JP3245956B, JP4691489B, and WO2013/121458 disclose such kind of information display devices and methods of displaying information.

JP2009-080710A discloses a data processing device. The data processing device includes a display device, a memory, a controller, and an external interface. On the display device, an operation menu display section, a main work section where data (information) is displayed, and a selective display section are displayed. In the main work section, a plurality of worksheets having tabs are displayed, superimposed to each other. By moving the tabs to change the display areas of the worksheets, the main work section is divided. Thus, in JP2009-080710A, the layout of the information can be changed as a user prefers by moving the tabs of the worksheets via the external interface.

JP3245956B discloses a layout device. The layout device includes a display unit which displays a paper sheet section as a displayed section, a dividing module which divides the paper sheet section into a plurality of data segments by dividing lines, a memory which stores a plurality of arrangement patterns in which positions of assignment segments of various kinds of material data (information) are defined by relative coordinates of the respective data segments, a selecting module which selects one of the stored arrangement patterns, a segment designing module which designs the assignment segments of the respective material data within the data segments based on the coordinates corresponding to the selected arrangement pattern, a data assigning module which assigns each material data into the corresponding designed segment, and a correcting module which corrects the dividing of the paper sheet section. In the layout device of JP3245956B, the data segments are formed as the layout of the information by dividing the paper sheet section with a dividing line, and the assignment segments of the material data are designed in the data segments. Further, the material data is assigned to each designed assignment segment. Moreover, to change the layout of the material data, the divided data segments are corrected, and based on the corrected data segments and the stored assignment coordinates of the material data, the material data can be rearranged without changing the assignment segments of the material data. Thus, in JP3245956B, in laying out paper sheets, a suitable layout of the paper sheets can be easily created, and further, the redesigning work of the material data when changing the layout can be reduced.

JP4691489B discloses an electronic terminal. The electronic terminal includes a memory, a controller, a dividing processing module, a layout processing module, and a screen display processing module. An information display screen is divided into a plurality of cells (information display segments), a cell is selected from the plurality of cells, and the selected cell is displayed in a large size as a main cell, on a display screen. The other cells are down scaled and displayed on the upper or lower side of the main cell, in a narrow shape. Thus, in JP4691489B, the display segment of the information specified by a user is enlarged and the entire contents of the information can be displayed.

WO2013/121458 discloses an information display device. The information display device includes a touch detecting module, an information acquiring module, a display unit having an information display mode and a layout creating mode, a first display control module which performs a control to display icons indicating information and display segments of the icons, and a second display control module which performs a control to display information regarding an icon selected from the above icons within an information display segment. In the information display device of WO2013/121458, an arrangement (layout) of the information display segments created in advance is selected and, by dragging the icon indicating the information to an intended disposition segment based on the arrangement, the information corresponding to the icon is displayed in the intended disposition segment. Thus, in WO2013/121458, the information display layout can be swiftly created with instinctive operation.

However, for a user looking at a display screen with the intention to obtain some sort of information, it is preferred to be able to swiftly and easily layout desired information in an eye-friendly size on the display screen and easily change the layout determined once, according to a change of the situation, etc.

In this regard, in JP2009-080710A, when adding information on the display screen, since the work of dividing the display screen by dragging the tabs via the external interface is required, it becomes more troublesome to the user.

In JP3245956B, it is not easy to change the sizes of the display information according to the sizes of divided segments.

In JP4691489B, the contents of the information displayed in the cells other than the main cell are displayed by being down scaled, or only a part of the contents is displayed. Therefore, with the configuration of JP4691489B, it is difficult to monitor two or more information simultaneously on a single display screen in an easily understandable manner.

In WO2013/121458, since the display size of the information is restricted to the size of the intended disposition segment, the display size of the information cannot be flexibly changed. Moreover, to change the arrangement (layout) of the information display, since the operation needs to be performed again from selecting the arrangement, it is troublesome to the user. Moreover, since the layout of the information display provided to the user is limited to the layout created in advance, the freedom of selection is small, and thus, there is a room for improvement.

### SUMMARY OF THE INVENTION

The purpose of this disclosure relates to providing an information display device, which is selectable of an item and size of information to be displayed, and is flexibly customizable of an information display layout as a user prefers.

According to a first aspect of this disclosure, an information display device with the following configuration is provided. Specifically, the information display device includes a display reference position selecting module, a display item selecting module, a display size selecting module, and a display unit. The display reference position selecting module allows a user to select, as an information display reference position, one of a plurality of rectangular unit segments formed by dividing an information item display target section from a display screen. The display item selecting module allows a user to select an item of information to be displayed in a part of the information item display target section determined based on the selected information display reference position. The display size selecting module acquires one or more displayable sizes that fit inside the part of the information item display target section, and allows a user to select, from the one or more displayable sizes, a size for the selected item to be displayed therein, each of the one or more displayable sizes being acquired based on the selected information display reference position from one or more applicable sizes that are prepared for the selected item to be displayed therein and correspond to an integral multiple of vertical and horizontal dimensions of each of the unit segments. The display unit displays the selected item in the selected size in the part of the information item display target section.

Thus, based on the selected information display reference position, options of the information size, which are limited to the displayable sizes of the display item, can be provided to the user. Therefore, a situation where an excessively large size is specified, and the selected item cannot be displayed within the part of the information item display target section and is not fully viewable, or a situation where an excessively large size is specified and an error is displayed does not occur. Thus, a user-friendly operation can be achieved. Moreover, an information display layout as the user prefers can be created without being limited to a predetermined screen dividing layout.

The display item selecting module preferably only allows the item that is displayable in the one or more applicable sizes in the part of the information item display target section to be selected.

Thus, only the items that have the one or more applicable sizes displayable in the part of the information item display target section among the applicable sizes prepared for the item, are provided to the user as options. Therefore, since the user can customize an information display layout without concerning that the selected display size cannot be displayed within the screen or the like, only by selecting the item to be displayed among the options already narrowed down, more user-friendly operation can be achieved.

The information display device preferably includes the following configuration. Specifically, when a rectangular segment of which diagonal line has an end at the unit segment selected as the information display reference position and the other end at the unit segment that is at the bottom right corner of the information item display target section is a disposition target segment, one or more sizes that fit inside the disposition target segment among the one or more applicable sizes are acquired as the displayable size by the display size selecting module, among the one or more applicable sizes. When the selected size of the selected item is larger than the size of a single unit segment, the rectangular segment in which the selected item is displayed by the display unit is formed by two or more of the unit segments and one of the left end, the upper end, and the upper left corner of the rectangular segment is at the selected information display reference position.

Thus, the display reference position of the item is always fixed to the unit segment at the upper left corner of the rectangular segment regardless of the number of the unit segments of which the display size selected to display the item occupies (upper left-based layout). Therefore, the user can perform operation of disposing the item comfortably with the understanding that the item is disposed with a fixed position-based layout no matter which item and size are specified. Moreover while users, in general, psychologically tend to arrange a plurality of information in the order from left to right or from upper to below, with the upper left-based layout, even when disposing the display information of which size is larger than that of a single unit segment, the display information does not easily overlap with the information already disposed, and thus, the frequency of rearranging the information can be reduced.

When a position of the selected item is specified to overlap with entire or a part of an item that is already displayed, the display unit preferably displays the selected item in the overlapped part.

Thus, the information can be displayed in a layout in which the latest intention of the user is reflected. Moreover, when the information already displayed is requested to be changed to different information, the different information can be displayed without requiring operation of deleting the information already displayed. Thus, the change of the information can be performed in the user-friendly manner by omitting the work of the user.

When the position of the selected item is specified to overlap with a part of the item already displayed, the display unit may display the item already displayed in a downsized manner in a part other than the part overlapped with the selected item.

Thus, the selected item can be displayed according to an intention of the user, and when the position of the selected item is overlapped with the part of the item already displayed, a layout of displaying the item already displayed and the selected item aligned can be proposed to the user.

When the position of the selected item is specified to overlap with a part of the item already displayed, the display unit may delete the item already displayed.

As above, by deleting the information other than desired information from the display unit, the view on the display screen can be simplified. Moreover, since operation of deleting the information already displayed is not required, the operation by the user becomes simple.

According to a second aspect of this disclosure, a method of changing a display layout of an information display device is provided. Specifically, the method of changing the display layout is a method of changing the display layout of an information item display target section of the information display device. The method includes allowing a user to select, as an information display reference position, one of a plurality of rectangular unit segments formed by dividing the information item display target section from a display screen. The method includes allowing a user to select an item of information to be displayed in a part of the information item display target section determined based on the selected information display reference position. The method includes acquiring one or more displayable sizes that fit inside the part of the information item display target section, and allowing a user to select, from the one or more displayable sizes, a size for the selected item to be displayed therein, each of the one or more displayable sizes being acquired based on the selected information display reference position from one or more applicable sizes that are prepared for the selected item to be displayed therein and correspond to an integral multiple of vertical and horizontal dimensions of each of the unit segments. The method includes displaying the selected item in the selected size in the part of the information item display target section.

Thus, based on the selected information display reference position, options of the information size, which are limited to the displayable sizes of the display item, can be provided to the user. Therefore, a situation where an excessively large size is specified, and the selected item cannot be displayed within the part of the information item display target section and is not fully viewable, or a situation where an excessively large size is specified and an error is displayed does not occur. Thus, a user-friendly operation can be achieved. Moreover, an information display layout as the user prefers can be created without being limited to a predetermined screen dividing layout.

### BRIEF DESCRIPTION OF THE DRAWING(S)

The present disclosure is illustrated by way of example and not by way of limitation in the figures of the accompanying drawings, in which the like reference numerals indicate like elements and in which:

FIG. 1 is a block diagram illustrating an overall configuration of a ship instrument network system;

FIG. 2 is a front view of an information display device;

FIG. 3 is a view illustrating unit segments defined by dividing an information item display target segment;

FIGS. 4A to 4E are views illustrating display sizes of five kinds of information;

FIGS. 5A and 5B are views illustrating selections of information display reference positions;

FIGS. 6A and 6B are views illustrating selections of items of the information;

FIGS. 7A and 7B are views illustrating selections of display sizes;

FIGS. 8C and 8D are views illustrating other selections of the display sizes;

FIG. 9 shows views illustrating a specific example of customizing a display screen; and

FIG. 10 is a flowchart illustrating processing performed by the information display device.

### DETAILED DESCRIPTION

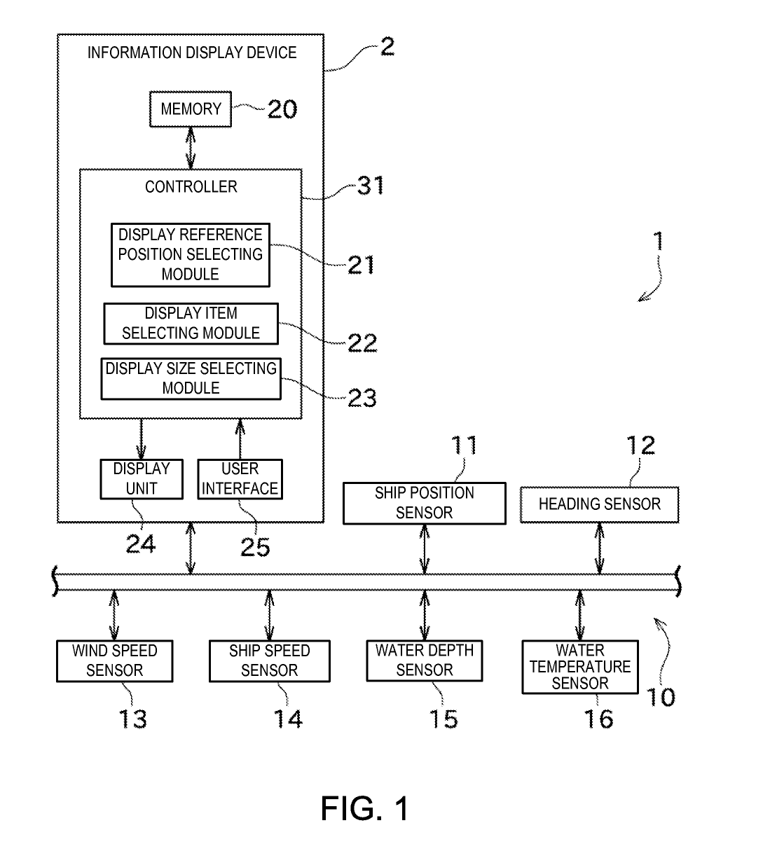

Next, one embodiment of this disclosure is described with reference to the appended drawings. FIG. 1 is a block diagram illustrating an overall configuration of a ship instrument network system.

A ship instrument network system 1 having an information display device 2 of this embodiment includes a plurality of ship instruments connected with a ship network 10. The ship instruments exchange detected information and the like, via the ship network 10. As the standard of the network 10, a LAN (Local Area Network) or a CAN (Controller Area Network) may be adopted, for example.

As illustrated in FIG. 1, the ship instrument network system 1 of this embodiment includes the information display device 2, a ship position sensor 11, a heading sensor 12, a wind speed sensor 13, a ship speed sensor 14, a water depth sensor 15, and a water temperature sensor 16.

Each of the ship position sensor 11, the heading sensor 12, the wind speed sensor 13, the ship speed sensor 14, the water depth sensor 15, and the water temperature sensor 16 acquires information regarding a ship where the respective components are installed (hereinafter, simply referred to as “the ship”) and a situation around the ship, and outputs them to the information display device 2. Note that, the sensors configuring the system are not limited to the above sensors, and other sensors configured to acquire information required for safe navigation or other information may be provided as needed, and the above sensors may suitably be omitted.

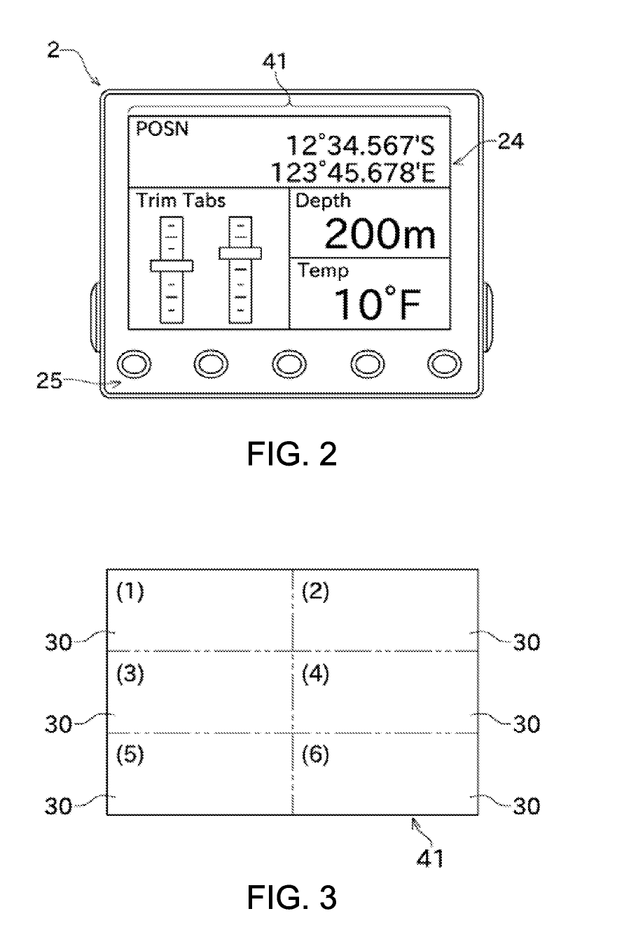

The information display device 2 creates information (data) based on the information detected by the above sensors and displays one or more information items selected by a user, at a selected position of a display screen in a selected size. FIG. 2 illustrates an example in which the information display device 2 simultaneously displays four items including a latitude and longitude (POSN), trim tabs (Trim Tabs), a water depth (Depth), and a water temperature (Temp).

In this embodiment, a rectangular information item display target section 41 is sectioned within the display screen of the information display device 2, and the items of the information are disposed within the information item display target section 41. The items displayed within the information item display target section 41 have various vertical and horizontal sizes. Further, the information display device 2 also changes (customizes) the formation of a view displayed within the information item display target section 41 as requested by the user.

Hereinafter, a specific configuration of the information display device 2 is described. As illustrated in FIG. 1, the information display device 2 includes a memory 20, a controller 31, a display unit 24, and a user interface 25.

The memory 20 is comprised of a ROM and a RAM, and stores various programs and data. The memory 20 is connected with the controller 31, and the controller 31 reads and writes the contents of the memory 20 as needed.

The display unit 24 includes a liquid crystal display unit and is connected with the controller 31. Through a control of the controller 31, the display unit 24 displays the information data from the sensors on the display screen (the information item display target section 41 described above) as illustrated in FIG. 2, and displays various setting screens and the like.

The user interface 25 includes a plurality of operation keys having a menu key, direction keys, an enter key, and a cancellation key. The user interface 25 is connected with the controller 31. The user controls the operation keys to perform operation regarding the information display (e.g., later-described selections of the item and display size of the information).

The controller 31 is comprised of a CPU and performs various operations and controls. The memory 20 stores suitable programs for achieving a method of changing a display layout of this disclosure. Thus, the controller 31 can operate as a display reference position selecting module 21, a display item selecting module 22, and a display size selecting module 23 when the user requests for the customization of the display screen.

Here, a unit based on which the layout when the information display device 2 of this embodiment displays the information data from the sensors on the display unit 24 is determined is described.

In other words, in the information display device 2, the information item display target section 41 where various information items are displayed is designed over the entire display screen of the display unit 24. Further, in the information display device 2, a plurality of rectangular unit segments 30 obtained by virtually dividing the information item display target section 41 are designed. Each unit segment 30 is used as a unit when the user specifies the position and size of the information to be displayed.

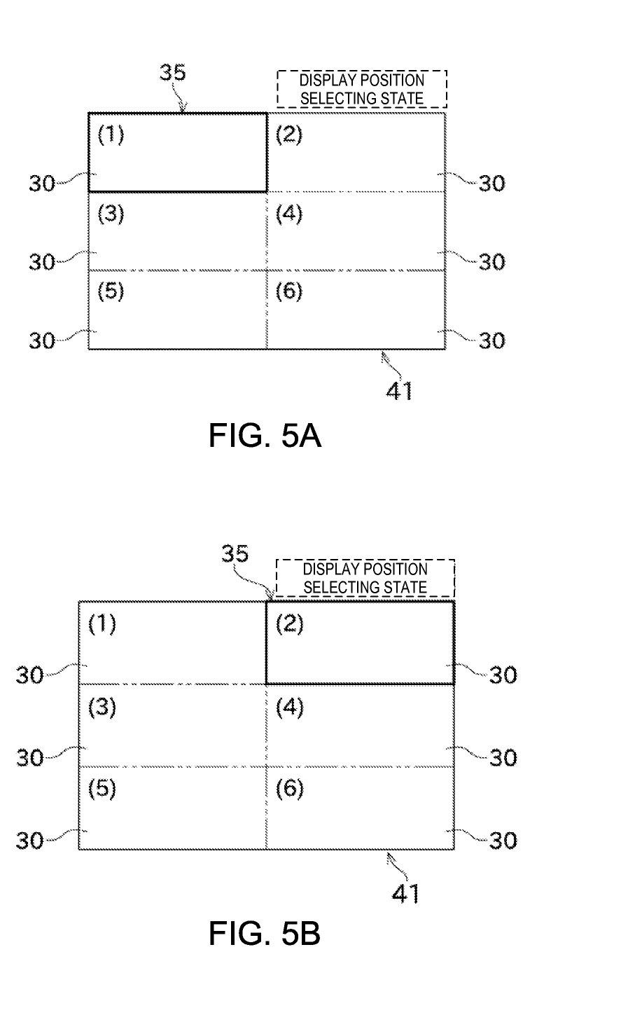

In this embodiment, as illustrated in FIG. 3, six unit segments 30 having the same shape are defined by dividing the information item display target section 41 into a matrix having two columns and three rows. In displaying the information data from the sensors on the display unit 24 (information item display target section 41), a grid layout based on the six unit segments 30 is adopted. Note that, in FIGS. 3, 5A, 5B and the like, the unit segments are denoted with numbers (1), (2), (3), (4), (5) and (6) in the order from left to right in terms of columns, and top to bottom in terms of rows, so as to easily specify the position of each unit segment in the description below. The numbers in parenthesis are used for the sake of convenience, and they are not actually displayed on the display screen of the display unit 24.

In the information display device 2, the items of the information which can be displayed within the information item display target section 41 described above are determined in advance. The items include a speed through water (STW), a heading (HDG), a course over ground (COG), the latitude and longitude (POSN), the water depth (Depth), and the water temperature (Temp), the trim tabs (Trim Tabs), an actual rudder angle/commanded rudder angle, a turning round angular speed, a wind direction, a wind speed, time; however, the items are not limited to these kinds.

To organize the items of the information in an easily understandable manner, categories including “Speed,” “Wind,” “Heading,” and “Course” are defined in the information display device 2. Each of the items of the information which can be displayed on the display screen is always assigned to one of the categories, for example, the heading (HDG) is categorized in “Heading” and the wind direction and the wind speed are categorized in “Wind.” The memory 20 stores assignment category information indicating combinations of the items with the categories assigned therewith.

Moreover, the items of the information described above include one or more items for which a plurality of sizes for displaying are prepared in terms of design in the information display device 2, and the user can select a display size therefrom. The applicable size in displaying on the display screen (hereinafter, may be referred to as the “applicable size”) is determined in consideration of the specification of the display design, depending on the item.

For example, for the item that is simply displayed as a single numeric value, such as the water depth (Depth) or the water temperature (Temp) in FIG. 2, in most cases, the item can be displayed by using a single unit segment, and may also be displayed in a larger size (other than a vertically long layout). On the other hand, for the item that is displayed by combining a plurality of numeric values (e.g., the latitude and longitude (POSN)), displayed graphically by imitating an analog meter (e.g., the trim tabs (Trim Tabs)), or displayed in a chart to clarify the relationship with a history record, a single unit segment is not prepared for displaying since the item requires bigger space, and only large sizes to some extent are prepared for displaying.

By using the size of the unit segment 30 as a unit, the applicable size is defined such that the vertical (row) and horizontal (column) dimensions become the integral multiple of the size of the unit segment. To describe in detail, five kinds of sizes are defined as sizes in which each item of the information can be displayed in this embodiment. The five kinds of sizes defined to display correspond to a single unit segment, two unit segments in two rows of one column, two unit segments in one row of two columns, four unit segments in two rows of two columns, six unit segments in three rows of two columns, respectively. Thus, each of the five kinds of sizes defined to display the items of the information has the vertical and horizontal dimensions corresponding to the integral multiple of the size of a single unit segment 30. Each item that can be displayed in the information display device 2 has at least one of the five sizes as its applicable size.

Note that, as described above, the unit segments are defined by dividing the display screen into the matrix having two columns and three rows in this embodiment. Therefore, the size corresponding to the six unit segments in three rows of two columns indicates that the corresponding item is solely displayed over the entire information item display target section 41.

The memory 20 provided to the information display device 2 stores applicable size information indicating the prepared sizes (applicable sizes) for each displayed item. For example, the heading (HDG) which is one of the displayable items in this embodiment has four kinds of applicable sizes including a single unit segment, two unit segments in one row of two columns, four unit segments in two rows of two columns, six unit segments in three rows of two columns, and the memory 20 stores information indicating such contents.

The display reference position selecting module 21 allows the user to select a unit segment to be used as the reference of the information display position, from the unit segments 30 in two rows and three columns within the information item display target section 41.

The display item selecting module 22 acquires the item that can be displayed within a disposition target segment based on a size of the disposition target segment and the applicable sizes stored in the memory 20. The disposition target segment is a rectangular segment of which diagonal line has an end at the unit segment selected by the display reference position selecting module 21 and the other end at the unit segment at the bottom right corner of the information item display target section 41. Further, the displayable items are displayed on the display screen as options so that the item requested by the user is selected from the options.

The display size selecting module 23 reads the applicable sizes defined for the item selected by the display item selecting module 22 from the memory 20, and among the applicable sizes, the display size selecting module 23 acquires the size that can currently be displayed within the disposition target segment currently selected. Note that, the display sizes acquired as above may be referred to as the “displayable sizes.” The display size selecting module 23 provides the obtained displayable sizes to the user as options so that the size requested by the user is selected from the options.

Next, specific operation of the information display device 2 is described. The information display device 2 can switch its state among a normal state, a display position selecting state, a category selecting state, a display item selecting state, and a size selecting state.

As illustrated in FIG. 2, in the normal state, the information detected by the sensors is displayed on the display unit 24, and the user can refer to the information.

As illustrated in FIGS. 5A and 5B, in the display position selecting state, the position (information display reference position) to be the reference when laying out the items displayed on the display screen can be selected.

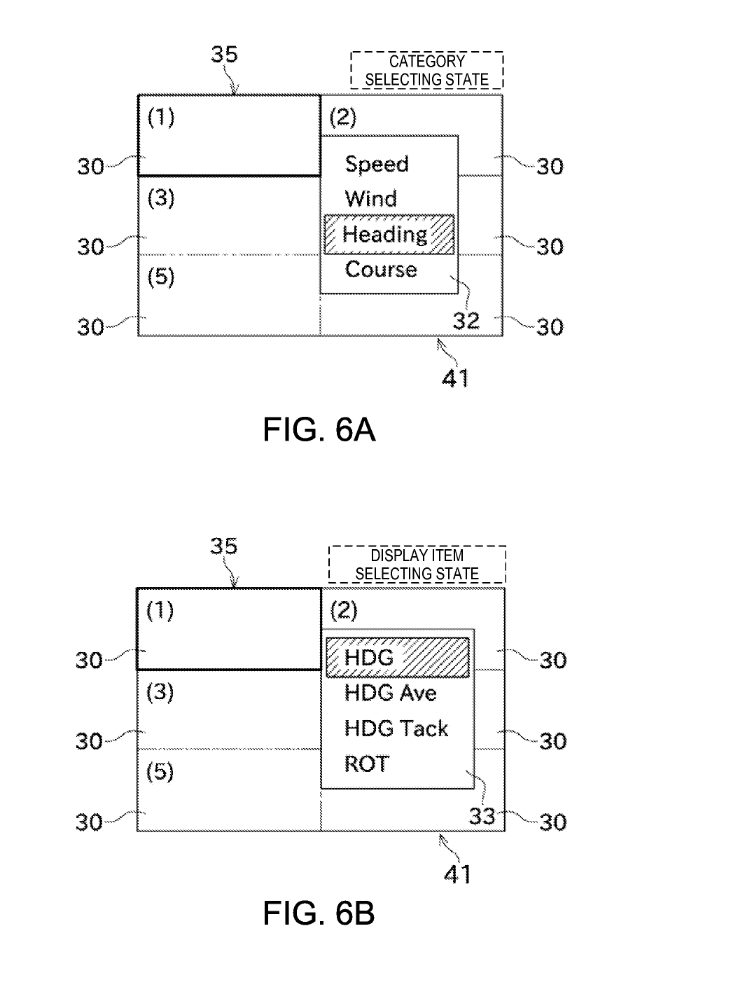

As illustrated in FIG. 6A, in the category selecting state, a popup menu 32 is displayed on the display screen, and the category to which the item to be displayed is assigned can be selected.

As illustrated in FIG. 6B, in the display item selecting state, a popup menu 33 is displayed on the display screen, and the item to be displayed can be selected.

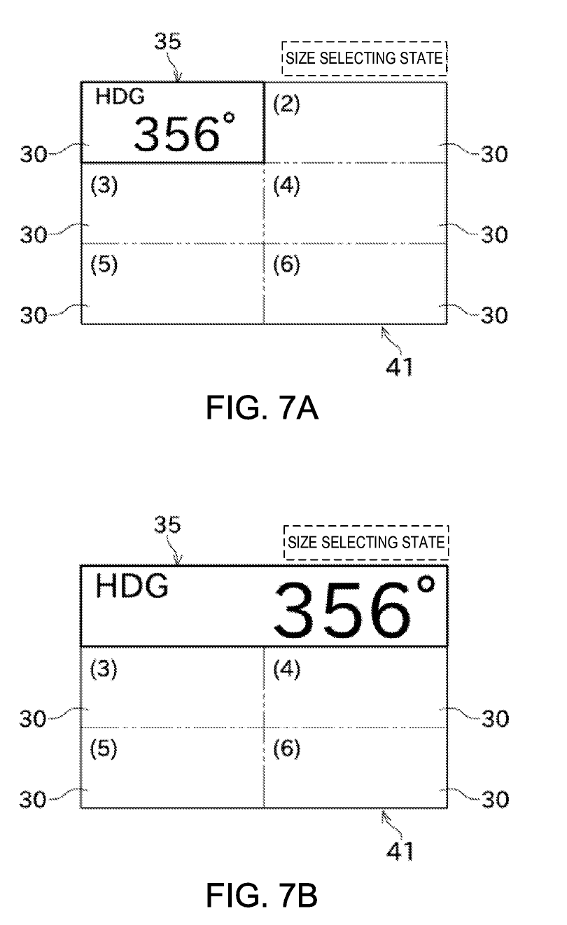

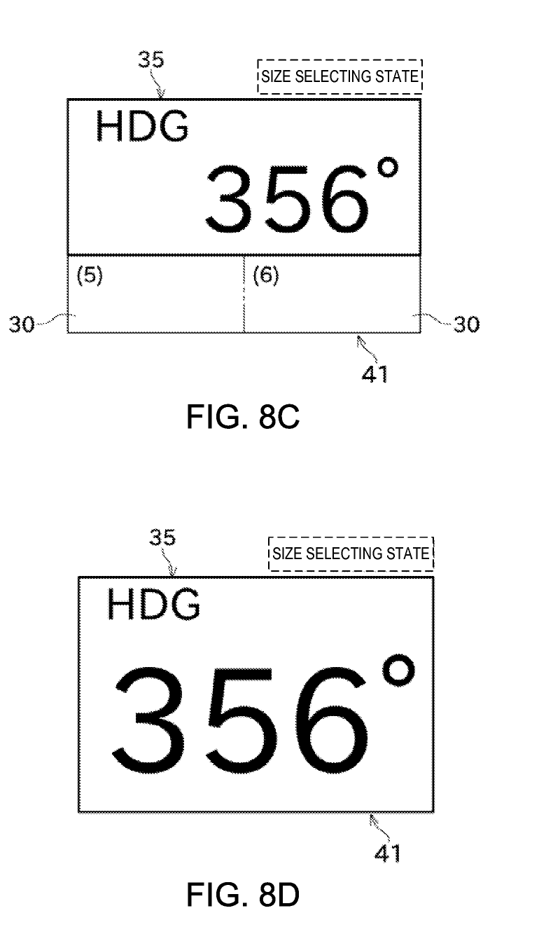

As illustrated in FIGS. 7A to 8D, in the size selecting state, the size of the item to be displayed on the display screen can be selected.

Next, the information display layout is described. The information display layout is a layout indicating the selection and disposition of the item to be displayed on the display unit 24 among the items of the information obtained from the sensors. The information display device 2 of this embodiment can create the information display layout as the user prefers, and can change (customize) the layout as needed.

Hereinafter, a method of creating the information display layout using this embodiment is described along the procedure of the operation by the user with reference to FIGS. 5A to 8D.

The user suitably controls the menu key and the like of the user interface 25 to instruct that the information display layout is newly created. Thus, as illustrated in FIGS. 5A and 5B, the information display device 2 becomes the display position selecting state where the information display reference position can be selected. In the display position selecting state, the information item display target section 41 is displayed without any information disposed therewithin and a select cursor 35 used to select one of the six unit segments 30 is displayed. The user moves the select cursor 35 to a desired position by controlling the direction keys of the user interface 25 in consideration of where to dispose the information, and presses the enter key to complete the selection of the information display reference position. It is assumed that the unit segment 30 with (1) is selected as the information display reference position in the current operation.

When the information display reference position is determined, the controller 31 of the information display device 2 shifts to the category selecting state and then the display item selecting state illustrated in FIGS. 6A and 6B, and two popup menus 32 and 33 are sequentially displayed to allow the user to select the item to be displayed at the information display reference position. Note that, the selectable items by the respective popup menus 32 and 33 are determined based on the information display reference position selected in the previous selecting operation and the applicable sizes of the information.

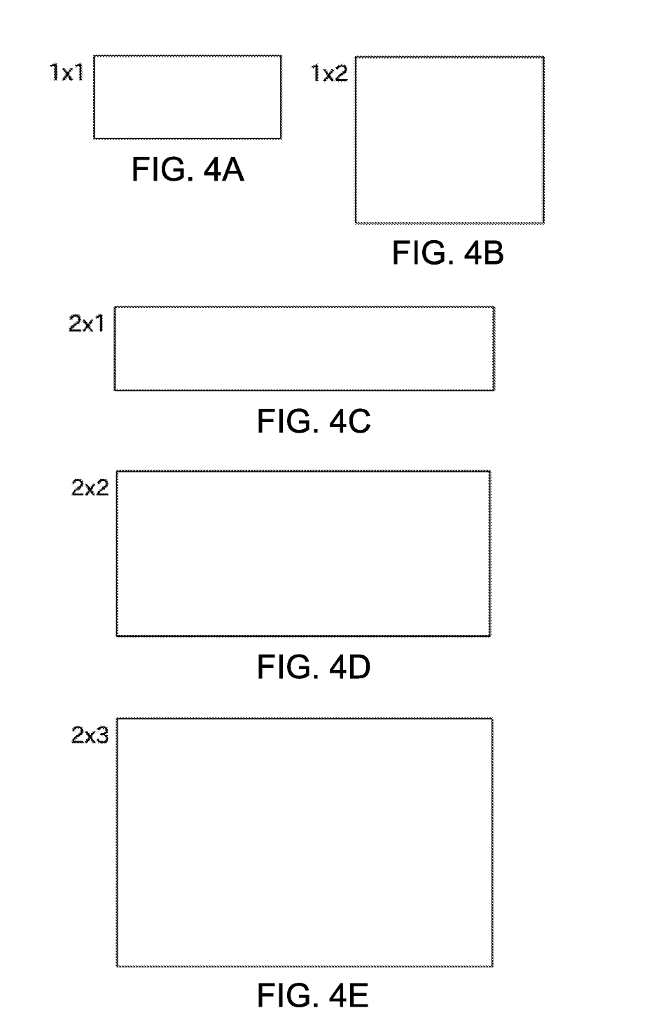

More specifically, when the information display reference position is selected, the controller 31 of the information display device 2 calculates the number of the unit segments 30 corresponding to the vertical and horizontal dimensions of a rectangular segment (the disposition target segment described above) of which diagonal line has an end at the unit segment 30 corresponding to the selected information display reference position and the other end at the unit segment 30 at the bottom right corner of the information item display target section 41. Since the unit segment 30 with (1) is selected in the current selecting operation, the disposition target segment forms a rectangle of which diagonal line has ends at the unit segment 30 with (1) and the unit segment 30 with (6) and a size corresponding to six unit segments in three rows of two columns. Therefore, it can be understood that any of the five kinds of sizes illustrated in FIGS. 4A to 4E can be displayed within the disposition target segment.

Each of the display items of this embodiment (e.g., the speed through water (STW), the heading (HDG), and the course on the ground (COG)) is designed to be displayable in at least one of the five kinds of sizes described above. Therefore, when the unit segment with (1) is selected as the information display reference position, all the items are presented to the user as the options.

On the other hand, for example, if the unit segment 30 with (5) is selected as the information display reference position, the disposition target segment corresponds to two unit segments in two rows of one column, which includes the unit segments 30 with (5) and (6). Therefore, within the disposition target segment, only two kinds of sizes corresponding to a single unit segment and corresponding to two unit segments in two rows of one column can be disposed among the five kinds of sizes illustrated in FIGS. 4A to 4E. Therefore, since the items for which neither of the kinds of sizes is prepared as the applicable size cannot be displayed, such items are excluded from the list of the options displayed in FIGS. 6A and 6B. In this embodiment, as described above, since only the items having the applicable sizes that are displayable within the disposition target segment are displayed on the display screen as the options, the user can be avoided from being confused.

The user selects the item which he/she requests to be displayed, by controlling the direction keys and the enter key of the user interface 25. Note that, the selection is performed by first selecting the category in the popup menu 32 (FIG. 6A) and then selecting the item assigned to the category in the popup menu 33 (FIG. 6B). Since the two step operations in which the category is selected and then the item is selected are provided in this embodiment as above, even when the number of the items is large, the user can easily find the desired item by following the category levels.

Note that, there may be a case where all of the items assigned to a single category do not have any applicable size that can be disposed within the disposition target segment. In this case, the category may be presented in the popup menu 32 in the category selecting state in FIG. 6A, and when the category is selected, a message, such as “This category does not include any item that can be displayed at the selected position,” may be displayed. Alternatively, a configuration in which the category cannot be selected in the popup menu 32 may be adopted.

When the item of the information to be displayed is selected, the information display device 2 shifts to the size selecting state illustrated in FIGS. 7A to 8D, and allows the user to select the display size of the item. Here, the display sizes presented as the options obviously exclude the size that cannot be disposed within the disposition target segment described above which is determined based on the selected information display reference position, from the applicable sizes prepared for the selected item. The applicable sizes of the heading (HDG) which is the currently selected item are, as described above, the four kinds of sizes corresponding to a single unit segment, two unit segments in one row of two columns, four unit segments in two rows of two columns, and six unit segments in three rows of two columns, respectively. Any of the four kinds of sizes can be disposed within the disposition target segment based on the currently specified information display reference position (corresponding to six unit segments in three rows of two columns). Therefore, the options presented by the information display device 2 to the user in the size selecting state are four kinds of sizes corresponding to a single unit segment (FIG. 7A), two unit segments in one row of two columns (FIG. 7B), four unit segments in two rows of two columns (FIG. 8C), and six unit segments in three rows of two columns (FIG. 8D).

Every time the user controls the direction keys of the user interface 25, the four kinds of display sizes (options) are sequentially displayed one by one on the display screen of the display unit 24 such as FIGS. 7A, 7B, 8C, 8D, and then 7A again. The options including the four kinds of display sizes are displayed in the form of a preview in which the item is actually disposed in the respective sizes, and therefore, the user can easily grasp the image of the item when it is actually displayed. The user can select one of the display sizes by pressing the enter key of the user interface 25 while the requested size is displayed.

Note that, in the display position selecting state of FIGS. 5A and 5B, for example, if the unit segment with (2) is selected as the information display reference position, the disposition target segment becomes the size corresponding to three unit segments in three rows of one column. Thus, among the five kinds of the applicable sizes illustrated in FIGS. 4A to 4E, only two kinds of sizes corresponding to a single unit segment and two unit segments in two rows of one column, respectively, can be disposed within the disposition target segment. Therefore, even if the item for which all of the five kinds of applicable sizes are prepared is selected in the following display item selecting state, the options of the display size (displayable size) presented to the user in the size selecting state only include two kinds of sizes corresponding to a single unit segment and two unit segments in two rows of one column, respectively. Since the unnecessary sizes are not displayed when the user selects the display size of the information in the first place as described above, the sizes in which the item can actually be disposed are obvious, and the layout creation can smoothly be performed.

As described above, the specifying of the position, the item, and the display size is completed, and thus, the selected item is displayed by actually being disposed at the selected position within the information item display target section 41 in the selected size. Then, the user specifies the unit segment 30 which is vacant, and repeats the operation of specifying the item to be displayed and the size thereof. Thus, the user can sequentially dispose the desired items on the display screen in the desired sizes.

Note that, the views in FIGS. 7A, 7B, 8C and 8D are previews of the four kinds of display sizes when the unit segment 30 with (1) is specified as the information display reference position. As it is clear from FIGS. 7A, 7B, 8C and 8D, in this embodiment, when the user specifies one of the sizes larger than a single unit segment 30 as the size of the item to be displayed, the item is disposed such that one of its left end, upper end, and upper left corner is at the selected information display reference position (the upper left based-layout). In other words, when one of the sizes larger than a single unit segment 30 is specified as the display size of the item, the item is displayed to develop to at least one of the right side and the lower side of the information display reference position, with respect to the selected information display reference position. Thus, in relation to the selected information display reference position, the user can easily grasp the segment where the information is actually disposed. Therefore, the layout of the display information can be performed more easily. Moreover, the upper left-based layout is excellent in that it suits the user's accustomed usage since users tend to fill the items to be displayed from the upper left corner of the display screen. In other words, as long as the items are arranged from left to right or up to down, the disposed position of the item does not overlap with the disposed position of the item disposed thereafter.

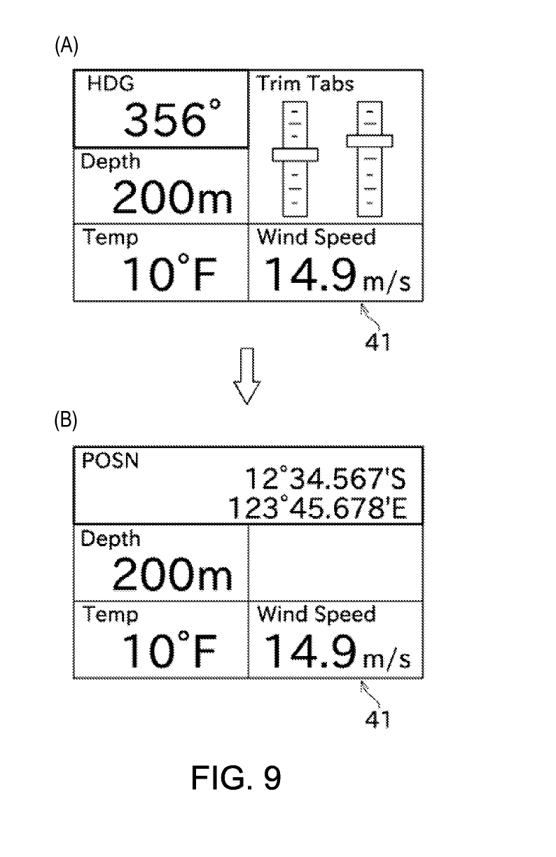

Subsequently, a case of changing the display information is described. For example, a case where the user requests to change the state of the information display device 2 from the state in part (A) of FIG. 9 to the state in part (B) of FIG. 9 is described.

The user instructs to change the information display layout by suitably controlling the menu key and the like of the user interface 25. Thus, the information display device 2 shifts from the normal state to the display position selecting state. The user moves the select cursor 35 displayed as illustrated in part (A) of FIG. 9, to the unit segment at the upper left corner where the heading (HDG) is displayed (corresponding to the unit segment 30 with (1) in FIG. 3), and presses the enter key. The information display device 2 shifts to the category selecting state and the display item selecting state next, where the user selects the latitude and longitude (POSN) as the item to be displayed. Then, the information display device 2 shifts to the size selecting state, where the user selects the size corresponding to two unit segments 30 in one row of two columns to be displayed. Thus, the heading (HDG) disposed on the display screen as part (A) of FIG. 9 and the trim tabs (Trim Tabs) disposed adjacently on the right side of the heading (HDG) are deleted from the display screen, and the latitude and longitude (POSN) is displayed at the corresponding parts in the size corresponding to two unit segments 30 in one row of two columns. The change of the display item is completed as described above, and the display screen layout is changed to such as the display screen as illustrated in part (B) of FIG. 9.

Thus, even when a boundary between items (i.e., a boundary for dividing the display screen) is changed as a result since the display sizes of the displayed items are different from the item to be displayed, the user is not required to perform a particular operation of changing the screen dividing layout, and the user is only required to select, as the information display reference position, the position of the information to be changed, and specify the desired item and the size thereof. Therefore, integrated operation of changing of the display item and the change of the screen dividing layout can be achieved simultaneously. Thus, the user can change the items of the information to be displayed and the arrangement thereof smoothly with a large degree of freedom and high functionality.

Note that, as illustrated in part (B) of FIG. 9, when the position of the latitude and longitude (POSN) which is the newly selected item overlaps with the positions of the heading (HDG) and the trip tabs (Trim Tabs) which are the previously selected items, the previously selected items are automatically deleted. Thus, when changing the information display layout, the layout can be changed to a desired layout by simply newly selecting the information without taking the previously selected information into consideration.

Note that, in the above example, the size of the trim tabs (Trim Tabs) corresponds to two unit segments in two rows of one column, and only the upper half thereof overlaps with the latitude and longitude (POSN) which is the newly selected item. Therefore, in the part where the trim tabs (Trim Tabs) is disposed, the lower half part which does not overlap with the newly selected item becomes blank as illustrated in part (B) of FIG. 9. When the previously selected item is overlapped, by deleting the previously selected item as above, a simple displayed view can be provided. Note that, if a size that can fit into the size of the blank (the size corresponding to a single unit segment) is prepared as the applicable size of the trim tabs (Trim Tabs), the trim tabs can be automatically displayed in the smaller size in the blank of part (B) of FIG. 9. In this case, the layout for displaying both of the latitude and longitude (POSN) and the trim tabs (Trim Tabs) aligned can be proposed to the user.

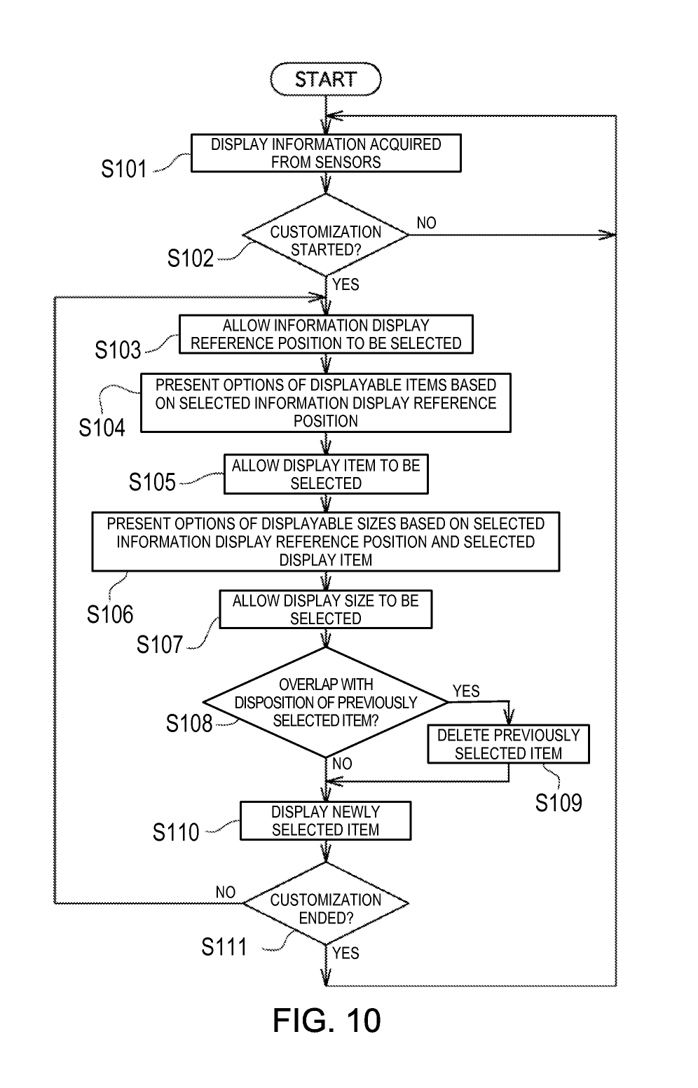

Next, processing performed by the information display device of this embodiment in the case of creating the information display layout is described. FIG. 10 is a flowchart illustrating the processing of the information display device when creating the information display layout.

As illustrated in FIG. 10, in the normal state, the controller 31 of the information display device 2 performs a control to display the information data acquired from the sensors on the display unit 24 (S101, in the normal state). Further, the controller 31 checks whether the operation to start the screen customization is performed by the user (S102). The information data is repeatedly displayed at S101 unless the operation to start the screen customization is performed.

When the instruction to start the screen customization is given by the user, the information display device 2 shifts from the normal state to the display position selecting state, and the controller 31 allows the user to select the information display reference position (S103). When the information display reference position is selected, the controller 31 shifts to the category selecting state and then to the display item selecting state and calculates the size of a rectangular segment (the disposition target segment) of which diagonal line has an end at the unit segment 30 selected as the information display reference position and the other end at the unit segment 30 at the right bottom corner of the information item display target section 41, and the controller 31 presents, as the options, the items for which the applicable sizes that can be disposed within the disposition target segment are prepared (S104). The user selects the desired item from the options (S105).

When the user selects the item to be displayed, the information display device 2 shifts to the size selecting state, and the controller 31 presents, as the options, to the user, the sizes that can be disposed within the disposition target segment among the applicable sizes prepared for the item (S106). The user selects the desired size from the options (S107).

When the user selects the size to be displayed, the controller 31 of the information display device 2 determines the segment where the newly selected item is to be displayed, and checks whether at least a part of the item displayed already overlaps with the segment (S108). If the item overlaps with the segment, the previously selected item is deleted (S109). Then, the newly selected item is displayed at the specified position in the specified size (S110).

Then, the controller 31 makes inquiry to the user for whether to end the screen customization (S111). When the user performs operation to end the customization, the flow returns to S101, and the information is displayed based on the customized screen layout. If the user performs operation to continue the customization, the flow returns to S103, and the above processing is repeated.

In the above flowchart, in the display layout changing method of this disclosure, the display reference position selecting corresponds to S103, the display item selecting corresponds to S105, the display size selecting corresponds S106 and S107, and the displaying corresponds to S110. By this processing, the options of the item and the display size which are not applicable to the display segment are not presented when accepting the selection of the user, and therefore, the operation by the user can be reduced. Moreover, the screen dividing layout is not required to be firmly determined first, and the disposition of the items and the determination of the dividing layout can be performed simultaneously. Therefore, more instinctive screen customization can be achieved. Further, since no restriction is made by a predesigned layout of the display screen, the screen customization with a large degree of freedom and high functionality can be provided as the user prefers and according to the change of the situation.

As described above, the information display device 2 of this embodiment includes the display reference position selecting module 21, the display item selecting module 22, the display size selecting module 23, and the display unit 24. The display reference position selecting module 21 causes the user to select, as the information display reference position, one of the plurality of unit segments 30 formed by dividing the information item display target section 41. The display item selecting module 22 causes the user to select the item of the information to be displayed at the selected information display reference position. The display size selecting module 23 acquires, based on the information display reference position, the displayable sizes at the information display reference position among the one or more applicable sizes prepared beforehand such that each applicable size corresponds to an integral multiple of the vertical and horizontal dimensions of a single unit segment so that the selected item is displayed therein, and the display size selecting module 23 causes the user to select the size in which the selected item is to be displayed, from the displayable sizes. The display unit 24 displays the selected item in the selected size at the selected information display reference position within the information item display target section 41.

Thus, based on the information display reference position, the options of the information size, which are limited to the displayable sizes of the display item, can be provided to the user. Therefore, a situation where an excessively large size is specified, and the selected item cannot be displayed within the information item display target section 41 and is not fully viewable, or a situation where an excessively large size is specified and an error is displayed does not occur. Thus, the user-friendly operation can be achieved. Moreover, the information display layout as the user prefers can be created without being limited to a predetermined screen dividing layout

Although the preferred embodiment of this disclosure is described above, the above configuration may be modified as follows.

In the above embodiment, the item without any applicable size which can be displayed within the disposition target segment described above is not displayed in the list of options to be presented to the user. In other words, only the items with one or more applicable sizes which can be displayed within the disposition target segment are displayed as the list of options. However, a modification may be made such that the item without any applicable size is displayed in a non-selectable state such as the grayed-out display manner, instead of not being displayed.

In the above embodiment, as illustrated in FIGS. 7A to 8D, the selection of the display size of the item is achieved by switching the preview screen. However, instead of this, a list of sizes may be displayed in a popup menu so that the user can select a size therefrom.

The selecting method of the category, the item, the display size and the like is not limited to the above embodiment, and a selecting method using a radio button or a pull down may be adopted.

In the above embodiment, the information item display target section 41 is designed over the entire display screen of the display unit 24. However, the information item display target section 41 may be designed in a part of the display screen. For example, in a case where the display screen has a header and a footer, it may be considered to design the information item display target section 41 in a part other than the header and the footer.

In the above embodiment, the unit segment 30 is defined by diving the information item display target section 41 into the two columns and three rows. However, the numbers of columns and rows of the divided information item display target section 41 may suitably be changed according to the size of the display screen, the display item, etc.

In the above embodiment, when the selected size is larger than a single unit segment 30, the selected item is displayed such that the selected information display reference position is at one of the left end, the upper end, or the upper left corner (the upper left-based layout). However, without limiting to this, the display reference position of the information may be changed as needed, for example, so-called upper right-based layout or so-called bottom left-based layout may be adopted.

In the above embodiment, in causing the user to select the item to be displayed, the user performs the two-step operations in which the category is selected and then the item is selected. However, the category selection may be omitted so that the item to be displayed is directly selected.

The information display device described above is not limited to be used as a display device for a ship, and may be used by being installed in other kinds of movable bodies.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. An information display device, comprising:
a display reference position selecting module configured to allow a user to select, as an information display reference position, one of a plurality of rectangular unit segments formed by dividing an information item display target section from a display screen;
a display item selecting module configured to allow a user to select an item of information to be displayed in a part of the information item display target section determined based on the selected information display reference position;
a display size selecting module configured to acquire one or more displayable sizes that fit inside the part of the information item display target section, and allow a user to select, from the one or more displayable sizes, a size for the selected item to be displayed therein, each of the one or more displayable sizes being acquired based on the selected information display reference position from one or more applicable sizes that are prepared for the selected item to be displayed therein and correspond to an integral multiple of vertical and horizontal dimensions of each of the unit segments; and
a display unit configured to display the selected item in the selected size in the part of the information item display target section.

2. The information display device of claim 1, wherein the display item selecting module only allows the item that is displayable in the one or more applicable sizes in the part of the information item display target section to be selected.

3. The information display device of claim 1, wherein when a rectangular segment of which diagonal line has an end at the unit segment selected as the information display reference position and the other end at the unit segment that is at the bottom right corner of the information item display target section is a disposition target segment, one or more sizes that fit inside the disposition target segment among the one or more applicable sizes are acquired as the displayable size by the display size selecting module, and
wherein when the selected size of the selected item is larger than the size of a single unit segment, the rectangular segment in which the selected item is displayed by the display unit is formed by two or more of the unit segments and one of the left end, the upper end, and the upper left corner of the rectangular segment is at the selected information display reference position.

4. The information display device of claim 1, wherein when a position of the selected item is specified to overlap with entire or a part of an item that is already displayed, the display unit displays the selected item in the overlapped part.

5. The information display device of claim 4, wherein when the position of the selected item is specified to overlap with a part of the item already displayed, the display unit displays the item already displayed in a downsized manner in a part other than the part overlapped with the selected item.

6. The information display device of claim 4, wherein when the position of the selected item is specified to overlap with a part of the item already displayed, the display unit deletes the item already displayed.

7. A method of changing a display layout of an information item display target section of an information display device, comprising:
allowing a user to select, as an information display reference position, one of a plurality of rectangular unit segments formed by dividing the information item display target section from a display screen;
allowing a user to select an item of information to be displayed in a part of the information item display target section determined based on the selected information display reference position;
acquiring one or more displayable sizes that fit inside the part of the information item display target section, and allowing a user to select, from the one or more displayable sizes, a size for the selected item to be displayed therein, each of the one or more displayable sizes being acquired based on the selected information display reference position from one or more applicable sizes that are prepared for the selected item to be displayed therein and correspond to an integral multiple of vertical and horizontal dimensions of each of the unit segments; and
displaying the selected item in the selected size in the part of the information item display target section.
